(19) United States
(12) Patent Application Publication
(10) Pub. No.: US 2008/0084814 A1
(43) Pub. Date: Apr. 10, 2008

(54) TECHNIQUES TO IMPROVE THE RELIABILITY OF THE COMMON CONTROL CHANNEL IN OFDM BASED WIRELESS SYSTEMS

(76) Inventor: Muthaiah Venkatachalam, Beaverton, OR (US)

Correspondence Address: INTEL CORPORATION;c/o INTELLEVATE, LLC, P.O. BOX 52050, MINNEAPOLIS, MN, 55402, US

(21) Appl. No.: 11/693,100

(22) Filed: Mar. 29, 2007

Related U.S. Application Data
(60) Provisional application No. 60/850,853, filed on Oct. 10, 2006.

(51) Int. Cl. H04J 11/00

(52) U.S. Cl. 370/203

(57) ABSTRACT

An embodiment of the present invention provides an apparatus, comprising a base station (BS) operable to communicate with at least one mobile station (MS), wherein the base station BS generates a dynamic or a pre-programmed offset before it begins the transmission of a frame.

### CROSS REFERENCE TO RELATED APPLICATIONS

This application claims the benefit of U.S. provisional application No. 60/850,853 filed 10 Oct. 2006, entitled, “TECHNIQUES TO IMPROVE THE RELIABILITY OF THE COMMON CONTROL CHANNEL IN OFDM BASED WIRELESS SYSTEMS.”

### BACKGROUND

MAP which is also referred to as common control channel is a very important aspect of an orthogonal frequency division multiplexing (OFDM) system, such as but not limited to, Worldwide Interoperability Microwave Access (WiMAX). MAP is transmitted at the beginning of every WiMAX frame (or equivalently WiMAX2 subframe). It is in the MAP that there are allocations for the various users for that frame. The users decode the MAP to understand where their allocations are and they either transmit on their allocation (on the Uplink) or receive their packets on their allocations (on the downlink).

The current issue with the MAP, or common control channel, in WiMAX is that it is always 100% loaded. In other words, all the base stations transmit the MAP at the same time. This means that MAP undergoes a lot of interference, which in turn leads to lower reliability on the reception of the MAP. This in turn may have serious consequences for the system performance (for example users can miss their scheduled Uplink transmissions or downlink receptions etc) since MAP is a very important control channel and needs to have near perfect reception by all the users in the system.

Thus, a strong need exists for techniques to improve the reliability of the common control channel in OFDM based wireless systems.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an illustration of the offset approach of an embodiment of the present invention; and

FIG. 2 is a system in accordance with an embodiment of the invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

In the following detailed description, numerous specific details are set forth in order to provide a thorough understanding of the invention. However, it will be understood by those of ordinary skill in the art that the invention may be practiced without these specific details. In other instances, well-known methods, procedures, components, units and/or circuits have not been described in detail so as not to obscure the invention.

Embodiments of the invention may be used in a variety of applications. Some embodiments of the invention may be used in conjunction with various devices and systems, for example, a transmitter, a receiver, a transceiver, a transmitter-receiver, a wireless communication station, a wireless communication device, a wireless Access Point (AP), a modem, a wireless modem, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, a network, a wireless network, a Local Area Network (LAN), a Wireless LAN (WLAN), a Metropolitan Area Network (MAN), a Wireless MAN (WMAN), a Wide Area Network (WAN), a Wireless WAN (WWAN) and devices and/or networks operating in accordance with at least existing IEEE 802.16, 802.16d, 802.16e standards and/or future versions and/or derivatives and/or Long Term Evolution (LTE) of the above standards, a Personal Area Network (PAN), a Wireless PAN (WPAN), units and/or devices which are part of the above WLAN and/or PAN and/or WPAN networks, one way and/or two-way radio communication systems, cellular radio-telephone communication systems, a cellular telephone, a wireless telephone, a Personal Communication Systems (PCS) device, a PDA device which incorporates a wireless communication device, a Multiple Input Multiple Output (MIMO) transceiver or device, a Single Input Multiple Output (SIMO) transceiver or device, a Multiple Input Single Output (MISO) transceiver or device, a Multi Receiver Chain (MRC) transceiver or device, a transceiver or device having “smart antenna” technology or multiple antenna technology, or the like.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations.

Currently MAP, which is the one of the most important control signals in WiMAX is transmitted at 100% loading in WiMAX. This means that the MAP suffers serious reliability issues and/or we need to use highly redundant channel coding on the MAP to overcome the interference effect (which will in turn tremendously impact the capacity).

An embodiment of the present invention provides a simple yet effective scheme to overcome the 100% loading on the MAP and thereby improve the reliability of the MAP reception as well as reduce the amount of redundant channel coding needed on the MAP.

An embodiment of the present invention provides a solution for improving the reliability for the common control channel (also referred to herein as a MAP). In an embodiment of the present invention, the present invention may be utilized for the WiMAX evolution (aka Wimax2) that is currently being developed, although the present invention is not limited in this respect. In an embodiment of the present invention, each base station (BS) generates some kind of a dynamic or a pre-programmed offset before it begins the transmission of a frame. For that frame, the BS then transmits the MAP at the offset that was generated. With a mechanism to ensure that different neighboring base stations generate different offsets, r( ), the present invention ensures that the MAPs from these base stations are not transmitted simultaneously thereby avoiding the 100% loading as described above.

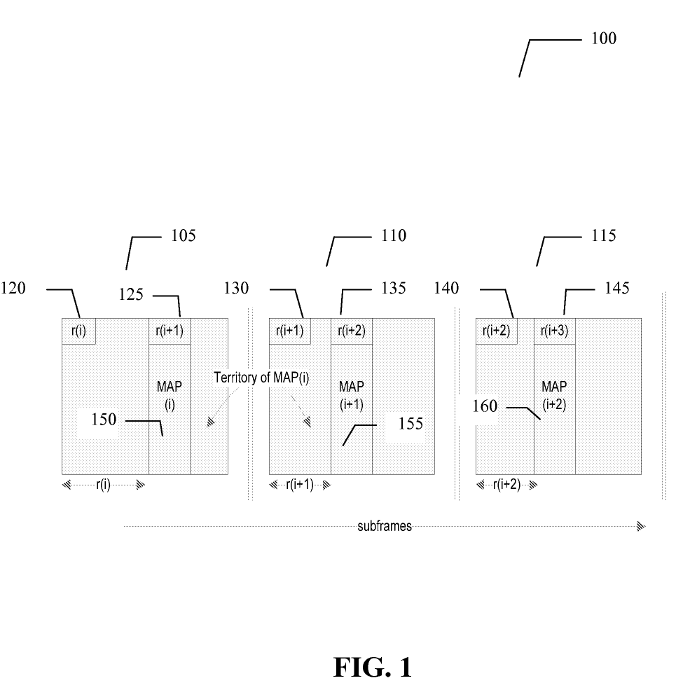

Turning now to the figures are details of the scheme of an embodiment of the present invention. FIG. 1 is an illustration of the offset approach of an embodiment of the present invention. At the beginning of each subframe i 105, 110 and 115 at the BS 100, where MAP is transmitted:
The BS 100 generates an offset r(i+1) 125 and 130;
The BS 100 starts the MAP 150 transmission for the subframe-i 105 after r(i) 120 symbols in the subframe 105;
As part of the MAP, it includes r(i+1) 125;
r(i) 120 will be needed by new or idle MS for system acquisition during frame-i 105;
r(i) 120 can be included at the beginning of the frame along with FCH;
or if r( ) is fixed for each BS, included once a while in DCD/UCD

The second subframe 110 shows the territory MAP(i) including r(i+1) 130 of subframe 110 in addition to r(i+1) of subframe 105. Subframe 110 also depicts r(i+2), 135 and MAP (i+1) 155.

The third subframe 115 shows r(i+2), 140 and MAP (i+2) 160 with r(i+3).

In order to generate the offsets, r( ), there are at least two distinct possibilities—although the present invention is not limited in this respect:
Possibility 1: r( ) is a bounded random variable; and
Possibility 2: fixed a-priori for each BS such a way that the neighbor BSs are transmitting data when current BS is transmitting MAP. In this case r( ) is transmitted only in the DCD and not every single frame.

The same scheme may be applied to telescopic MAPs as well, wherein the start of the telescopic MAP in each frame can be offset by the variable r( ).

Some embodiments of the invention may be implemented by software, by hardware, or by any combination of software and/or hardware as may be suitable for specific applications or in accordance with specific design requirements. Embodiments of the invention may include units and/or sub-units, which may be separate of each other or combined together, in whole or in part, and may be implemented using specific, multi-purpose or general processors or controllers, or devices as are known in the art. Some embodiments of the invention may include buffers, registers, stacks, storage units and/or memory units, for temporary or long-term storage of data or in order to facilitate the operation of a specific embodiment.

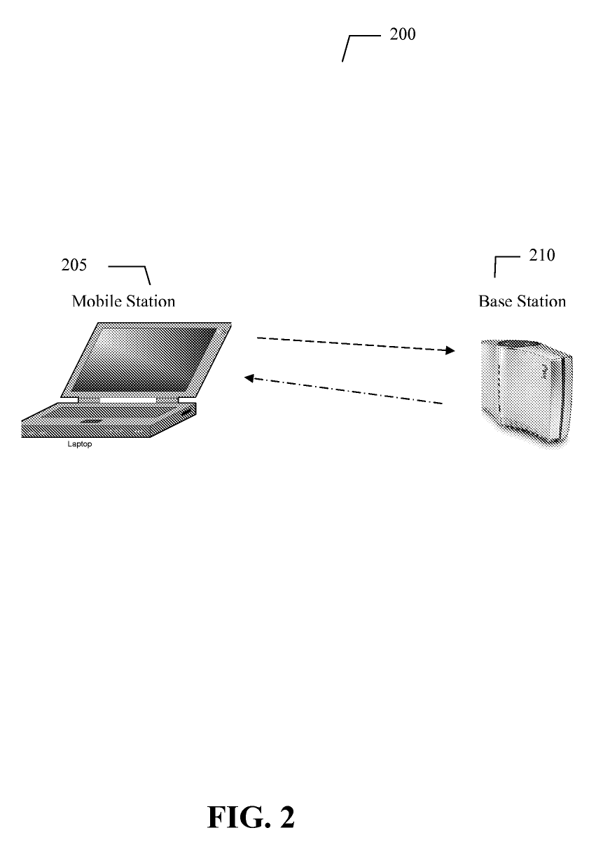

Some embodiments of the invention may be implemented, for example, using a machine-readable medium or article which may store an instruction or a set of instructions that, if executed by a machine, for example, by system 200 of FIG. 2, by mobile station 205 in communication with base station 210, by a processor or by other suitable machines, cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software.

The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like. In an embodiment of the present invention, the machine-accessible medium that provides instructions, which when accessed, may cause a machine to perform operations comprising generating a dynamic or a pre-programmed offset before a base station (BS) begins the transmission of a frame to a mobile station (MS).

The machine-accessible medium that provides instructions may further comprise further instructions, which when accessed, cause a machine to further perform operations comprising ensuring by said BS that different neighboring base stations generate different offsets so the common control channels from said base stations are not transmitted simultaneously thereby avoiding 100% loading.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

We claim:

1. An apparatus, comprising:
a base station (BS) operable to communicate with at least one mobile station (MS), wherein said base station BS generates a dynamic or a pre-programmed offset before it begins the transmission of a frame.

2. The apparatus of claim 1, wherein said offset is a dynamic offset.

3. The apparatus of claim 1, wherein said offset is a pre-programmed offset.

4. The apparatus of claim 1, wherein said BS ensures that different neighboring base stations generate different offsets so the common control channels from said base stations are not transmitted simultaneously thereby avoiding 100% loading.

5. The apparatus of claim 1, wherein said base station is in communication with said at least one mobile station according to an Institute for Electronic and Electrical Engineers (IEEE) 802.16e standard.

6. A method, comprising:
generating a dynamic or a pre-programmed offset before a base station (BS) begins the transmission of a frame to a mobile station (MS).

7. The method of claim 6, wherein said offset is a dynamic offset.

8. The method of claim 6, wherein said offset is a pre-programmed offset.

9. The method of claim 6, further comprising ensuring by said BS that different neighboring base stations generate different offsets so the common control channels from said base stations are not transmitted simultaneously thereby avoiding 100% loading.

10. The method of claim 6, further comprising communicating by said base station is in communication with said at least one mobile station according to an Institute for Electronic and Electrical Engineers (IEEE) 802.16e standard.

11. A machine-accessible medium that provides instructions, which when accessed, cause a machine to perform operations comprising:
generating a dynamic or a pre-programmed offset before a base station (BS) begins the transmission of a frame to a mobile station (MS).

12. The machine-accessible medium that provides instructions of claim 11, further comprising further instructions, which when accessed, cause a machine to further perform operations comprising:
ensuring by said BS that different neighboring base stations generate different offsets so the common control channels from said base stations are not transmitted simultaneously thereby avoiding 100% loading.

13. The machine-accessible medium that provides instructions of claim 11, wherein said offset is a dynamic offset.

14. The machine-accessible medium that provides instructions of claim 11, wherein said offset is a pre-programmed offset.

15. The machine-accessible medium that provides instructions of claim 11, further comprising further instructions, which when accessed, cause a machine to further perform operations comprising communicating by said base station is in communication with said at least one mobile station according to an Institute for Electronic and Electrical Engineers (IEEE) 802.16e standard.

16. A system, comprising:
a mobile station (MS);
a base station (BS) operable to communicate with said mobile station (MS), wherein said base station is adapted to generate a dynamic or a pre-programmed offset before it begins the transmission of a frame.

17. The system of claim 16, wherein said offset is a dynamic offset.

18. The system of claim 16, wherein said offset is a pre-programmed offset.

19. The system of claim 16, wherein said BS ensures that different neighboring base stations generate different offsets so the common control channels from said base stations are not transmitted simultaneously thereby avoiding 100% loading.

20. The apparatus of claim 1, wherein said base station is in communication with said at least one mobile station according to an Institute for Electronic and Electrical Engineers (IEEE) 802.16e standard.
